(19) United States
(12) Patent Application Publication
(10) Pub. No.: US 2018/0037352 A1
(43) Pub. Date: Feb. 8, 2018

(54) THERMOFORMING PACKAGING MACHINE WITH HOLDING STRIP

(71) Applicant: MULTIVAC Sepp Haggenmüller SE & Co. KG, Wolfertschwenden (DE)

(72) Inventor: Frank Lauth, Wolfertschwenden/Niederdorf (DE)

(21) Appl. No.: 15/667,357

(22) Filed: Aug. 2, 2017

(30) Foreign Application Priority Data
Aug. 4, 2016 (DE) 10 2016 214 431.6

(51) Int. Cl. B65B 47/10; B29C 51/10; B29C 51/18; B65B 41/02; B29C 51/26

(52) U.S. Cl. CPC B65B 47/10; B65B 41/02; B29C 51/262; B29C 51/18; B29C 51/10; B29L 2031/712

(57) ABSTRACT

A thermoforming packaging machine having an unwinding device for a bottom film web and a film conveying apparatus for intermittently conveying the bottom film web in a production direction using clamp chains. The packaging machine includes a holding strip for the bottom film web, the holding strip disposed in the intake area of the clamp chains. The holding strip is configured to hold part of a free leading end of a new bottom film web to be fed while and/or until the new bottom film web is gripped by the clamp chains and subsequently conveyed by the clamp chains.

### CROSS-REFERENCE TO RELATED APPLICATIONS

This Application claims priority to German Patent Application No. 10 2016 214 431.6, filed on Aug. 4, 2016, to Frank Lauth, currently pending, the entire disclosure of which is incorporated herein by reference.

### FIELD OF THE INVENTION

The present invention relates to a thermoforming packaging machine having a holding strip to hold at least a portion of a free leading end of a bottom film web during and/or until the bottom film web is gripped by the clamping/clamp chains for conveyance through the machine.

### BACKGROUND OF THE INVENTION

EP 126878 A1 discloses a thermoform packaging machine with clamp chains for conveying a bottom film web. The clamp chains take hold of a newly fed bottom film web at the front end of the thermoform packaging machine. The leading free end of the bottom film web is manually fed, a deflection device provides for the alignment of the bottom film web with the open clamps of the clamp chain. This intake area for the bottom film web is provided with protection covers against access of the operator to the machine interior. Films/foils having different thicknesses may be used, which exhibit different behaviors when they are introduced in the machine. Hence, it is common practice and in most cases also necessary that the operator holds the bottom film web, after insertion, with one hand at this position, so that the clamp chain will be able to take hold of the bottom film web during the next feed motion. This entails the risk that fingers may be drawn into the small opening provided for the film web, and it is also non-ergonomic, since the operator has to press with his other, free hand the pushbutton for advancing the clamp chains. The movement of the clamp chains is not always started immediately, but, depending on the state of the machine, it may be started later on and thus unexpectedly.

### SUMMARY OF THE INVENTION

It is the object of the present invention to provide a thermoform packaging machine that allows the operator to introduce a new bottom film web in an improved manner.

The thermoforming packaging machine according to the present invention may comprise an unwinding device for a bottom film/foil web and a film conveying apparatus for intermittently conveying the bottom film web in a production direction using clamp chains. According to the present invention, the thermoforming packaging machine is characterized in that a holding strip for the bottom film web is provided in the intake area of the clamp chains. When the machine is started or when a new bottom film is inserted, the holding strip may be configured to hold part of a free leading end of the new bottom film web to be fed while and/or until the bottom film web is gripped by the clamp chains and conveyed. It is therefore no longer necessary that the operator manually hold the bottom film web at the position required for until the film feed takes over. Manually holding the bottom film for this purpose poses a risk that fingers may, at least partially, be drawn into the opening on the machine frame is excluded. Consequently, as far as the operator is concerned, two successive steps may be provided: first, feeding the new film up to the holding strip and then, second, triggering of a film feed.

The holding strip may comprise at least one holding pocket connected to a vacuum generator so as to hold a portion of the bottom film web covering the holding pocket using a vacuum on the holding strip.

Between the vacuum generator and the holding strip, a valve may be provided in one embodiment so that one or a plurality of holding pockets can be cut off from the vacuum and switched on, also within a very short period of time.

According to an advantageous embodiment, the holding pocket may be configured as an elongated groove that is able to obtain a sufficiently large holding area and to also apply a sufficiently strong holding force to the film/foil. Also comparatively rigid foils having a thickness of up to approx. 500 μm can be held in this way.

In one embodiment, a downholder may be provided for guiding the bottom film web towards the holding pocket of the holding strip, so as to bring the film as close as possible to the holding strip, so that the film will be sucked onto the holding strip more reliably.

In one embodiment, a deflection guide may be provided upstream of the holding strip on both sides for feeding the bottom film web in the production direction. This provides an operational advantage in that the operator must feed the film at the deflection guide and that the film will be guided via the deflection guide and the downholder up to the holding strip.

In one embodiment, the holding strip may comprises a seal extending circumferentially around at least one holding pocket, so as to support the holding of the film and maximize the holding force by minimizing the amount of erroneously indrawn air.

Other aspects and advantages of the present invention will be apparent from the following detailed description of the preferred embodiments and the accompanying drawing figures.

### DESCRIPTION OF THE SEVERAL VIEWS OF THE DRAWING

In the following, an advantageous embodiment of the present invention will be explained in more detail making reference to a drawing, in which the individual figures show:

FIG. 1 is a schematic side view of one embodiment of a thermoform packaging machine in accordance with the teachings of the present invention;

FIG. 2 is an enlarged portion of the schematic side view of the thermoform packaging machine of FIG. 1;

FIG. 3 is a further enlarged portion of the schematic side view of the thermoform packaging machine of FIG. 1 showing the holding strip;

FIG. 4 is a top view of one embodiment of a holding strip of a thermoform packaging machine in accordance with the teachings of the present invention; and

FIG. 5 a top view of another embodiment of a holding strip of a thermoform packaging machine in accordance with the teachings of the present invention.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

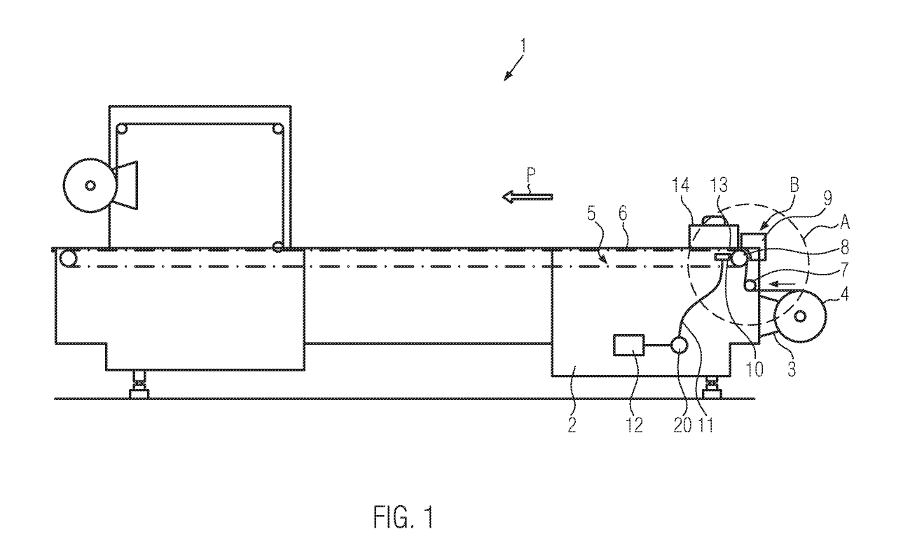

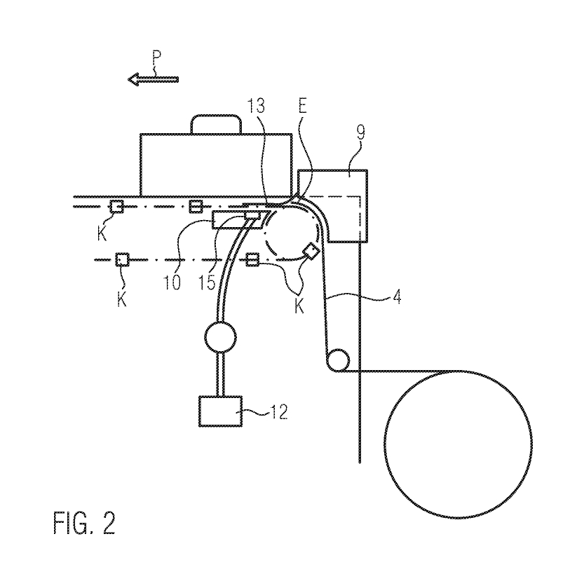

FIG. 1 shows a schematic side view of a thermoforming packaging machine 1 according to one embodiment of the present invention. The thermoforming packaging machine 1 may comprise a machine frame 2, an unwinding device 3 for a bottom film web 4 and a film conveying apparatus 5 with two clamp chains 6, wherein the routing of clamp chains 6 is schematically shown as a dot-and-dash line. The bottom film web 4 is unwound from a roll and, via a deflection pulley 7, guided upwards to the clamp chains 6. Between a deflection device 8 and a guide device 9, the bottom film web 4 is given an approximately horizontal orientation parallel to the upper chain span of the clamp chains 6 so that it can be gripped by the clamps K of the clamp chains 6 (cf. FIG. 2) on both sides thereof. The area defined as intake area B of the clamp chains 6 is the upper chain span area which is moved in the production direction P and in which the clamps K are opened and closed again for gripping the bottom film web 4. In the closed condition, i.e. downstream of the intake area B, the bottom film web 4 is fixedly held by the clamp chain 6 on both sides thereof.

In the area 10, in which the clamps K of the clamp chains 6, which are not shown in detail and which were previously open, close, as is also described in more detail according to the prior art in EP 126878 A1, a holding strip 10 is provided, which is connected to a vacuum generator 12 via a line 11. The mode of operation of the holding strip 10 will be explained in more detail in the following figures. A downholder 13 is provided downstream of the guide device 9, when seen in the production direction P, for guiding the leading end of the new bottom film web 4 to the holding strip 10 during insertion. The guide device 9 may be arranged on the machine frame 2 or on a protection cover 14, wherein the protection cover 14 rests in particular on the machine frame above the area 10 and which protects the latter against unauthorized access.

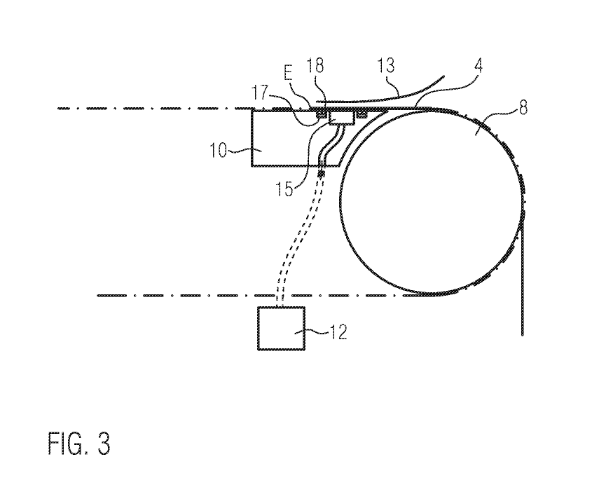

FIG. 2 shows an enlarged detail A of FIG. 1 at a position at which the leading end E of the new bottom film web 4 has been advanced along the guide device 9 up to a position below the downholder 13. The holding strip 10 has at least one pocket 15, which is connected to the vacuum generator 12 so as to suck the bottom film web 4 onto the upper side of the holding strip 10 and hold it in this way, when, as shown in FIG. 3, the bottom film web 4 has been advanced beyond the pocket 15 in the production direction P.

FIG. 3 shows an enlarged detail of FIG. 2 in a condition in which the bottom film web 4 has been sucked onto the holding strip 10. The arrow indicates the direction of the suction effect created by the vacuum generator 12. The vacuum generator 12 may e.g. be a vacuum pump, a suction fan or a Venturi nozzle. The downholder 13 is configured such that, when the film web 4 is manually inserted by the operator, the film end E will be advanced further and further towards the holding strip 10, so that the suction effect at the holding pocket 15 will suffice to suck the bottom film web 4 onto the holding strip 10 and to hold it there. Optionally, a groove 17 may be provided, which extends circumferentially around the holding pocket 15 and which has inserted therein a seal 18 which slightly projects beyond the surface of the holding strip 10. Preferably, the seal 18 is configured as a silicone seal or as a bead consisting e.g. of foam rubber.

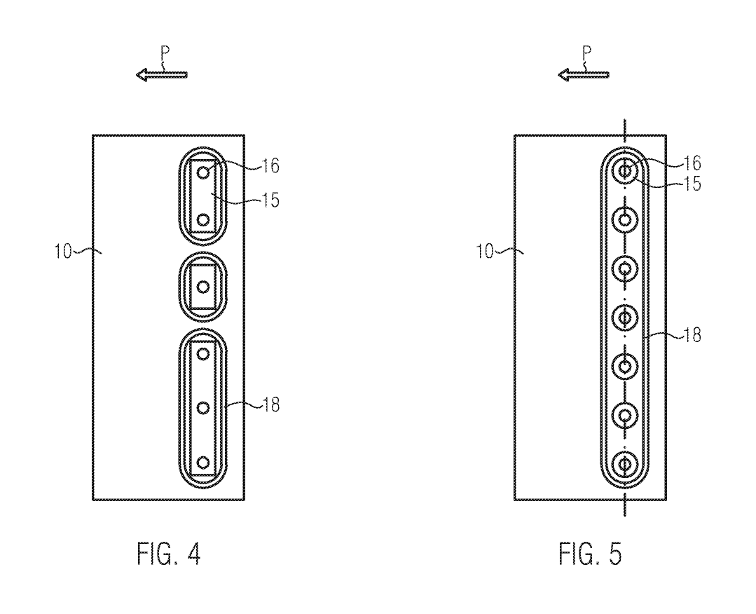

FIG. 4 shows a top view of an advantageous embodiment of the holding strip 10 comprising a plurality of holding pockets 15, each of them configured as a narrow groove and having one or a plurality of vacuum openings 16 through which a suction flow and a vacuum are generated. Around the holding pockets 15, the seal 18 is shown, which extends circumferentially around the respective holding pocket 15.

FIG. 5 shows an alternative embodiment of the holding strip 10 comprising round holding pockets 15, which are arranged along a line oriented orthogonally to the production direction P. Each holding pocket 15 is connected to the vacuum generator 12 via a separate vacuum opening 16 using the line 11. It is also possible to provide valves, which are not shown in detail and which are used for separating individual pockets 15 or a plurality of pockets 15 from the vacuum source 11, when a bottom film web 4 having a smaller width is inserted and when not all the holding pockets 15 are covered by the bottom film web 4 in this case. A seal 18 which is common to all the holding pockets 15 and which extends therearound is shown.

The present invention also covers embodiments of a holding strip 10, which consist of a combination of the holding strips 10 shown in FIGS. 4 and 5.

In addition, an embodiment of the thermoform packaging machine 1 according to the present invention is imaginable, in the case of which the holding strip 10 is located above the fed bottom film web 4 and the “downholder” 13 is located below the bottom film web 4, so that it lifts the latter upwards against the holding strip 10.

The sequence of steps at the production start with a new bottom film web 4 to be fed is described as follows hereinafter. The vacuum generator 12 is switched on or connected via a valve 20, so that a vacuum effect will prevail at the desired holding pockets 15 of the holding strip 10. The bottom film web 4 is now advanced along the guide device 9 up to the holding strip 10, so that the bottom film web will project beyond the pockets 15. Since the bottom film web 4 is guided using the downholder 13 to the holding strip 10 and the holding pocket 15, the bottom film web 4 is sucked onto the holding strip 10 and held there by the vacuum applied. The operator can now remove his hands from the film 4 and activate the feed start. Since the clamp chains 6 move in the production direction P and the clamps K are closed simultaneously, the bottom film web 4 will be gripped on both sides thereof and conveyed in the production direction P. In the course of this process, the bottom film web 4 detaches from the holding pockets 15 and the vacuum generator 12 is switched off, or the holding pocket 15 is cut off from the vacuum using the valve 20. Here, a so-called hold time may be stored in a control unit of the thermoform packaging machine 1, said control unit controlling the switch-off point for the vacuum. It will also be advantageous to provide an adjusting device for the vacuum, so as to be able to react to different bottom film webs 4 and to adjust the pull-away torque when the feed is started.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions and methods described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A thermoforming packaging machine comprising:
an unwinding device for a bottom film web; and
a film conveying apparatus having clamp chains for intermittently conveying the bottom film web in a production direction;
a holding strip for the bottom film web disposed proximate an intake area of the clamp chains, wherein said holding strip is configured to hold part of a free leading end of a new bottom film web to be fed while and/or until the bottom film web is gripped by the clamp chains for conveyance.

2. The thermoforming packaging machine according to claim 1, wherein the holding strip comprises at least one holding pocket in fluid communication with a vacuum generator, said vacuum generator generating a vacuum at said at least one holding pocket to hold a portion of the bottom film web covering the holding pocket on the holding strip.

3. The thermoforming packaging machine according to claim 2, wherein a valve is provided between the vacuum generator and the holding strip.

4. The thermoforming packaging machine according to claim 2, wherein the holding pocket is configured as an elongate groove.

5. The thermoforming packaging machine according to claim 2, wherein a downholder is provided for guiding the bottom film web towards the at least one holding pocket of the holding strip.

6. The thermoforming packaging machine according to claim 2, wherein the holding strip comprises a seal extending circumferentially around at least one holding pocket.

7. The thermoforming packaging machine according to claim 1, further comprising a deflection guide disposed upstream of the holding strip and on both sides of the thermoforming packaging machine for feeding the bottom film web in the production direction toward the holding strip.

8. The thermoforming packaging machine according to claim 2, further comprising a deflection guide disposed upstream of the holding strip and on both sides of the thermoforming packaging machine for feeding the bottom film web in the production direction toward the holding strip.

9. The thermoforming packaging machine according to claim 5, further comprising a deflection guide disposed upstream of the holding strip and on both sides of the thermoforming packaging machine for feeding the bottom film web in the production direction toward the holding strip.
